(19) United States
(12) Patent Application Publication
(10) Pub. No.: US 2018/0368036 A1
(43) Pub. Date: Dec. 20, 2018

(54) Network Node, Radio Network Nodes, Wireless Device and Methods Performed Therein

(71) Applicant: Telefonaktiebolaget LM Ericsson (publ), Stockholm (SE)

(72) Inventor: Johan Rune, Lidingö (SE)

(21) Appl. No.: 15/532,523

(22) PCT Filed: Jul. 8, 2016
(86) PCT No.: PCT/SE2016/050705

§ 371 Date: Jun. 2, 2017

(51) Int. Cl. H04W 36/00; H04W 24/10; H04W 76/11; H04W 36/10; H04W 4/80

(52) U.S. Cl. CPC H04W 36/00837; H04W 24/10; H04W 84/18; H04W 36/10; H04W 4/80; H04W 76/11

(57) ABSTRACT

Embodiments herein relate to a method performed by a first radio network node for enabling detection of one or more radio network nodes in a wireless communication network (1). The first radio network node (12) triggers an initiation of a transmission of a signal of identification from the one or more radio network nodes, wherein first radio network node (12) transmits a request to a network node (13,16) requesting activation of the transmission of the signal of identification from the one or more radio network nodes.

### TECHNICAL FIELD

Embodiments herein relate to a network node, radio network nodes, a wireless device and methods therein. In particular, embodiments herein relate to enabling detection of a second radio network node in a communication network.

### BACKGROUND

In a typical communication network, wireless devices, also known as wireless communication devices, mobile stations, stations (STA) and/or user equipments (UE), communicate via a Radio Access Network (RAN) to one or more core networks (CN). The RAN covers a geographical area which is divided into service areas or cell areas, with each service area or cell area being served by a radio network node such as a radio access node e.g., a Wi-Fi access point or a radio base station (RBS), which in some networks may also be denoted, for example, a “NodeB” or “eNodeB”. A service area or cell area is a geographical area where radio coverage is provided by the radio network node. The radio network node communicates over an air interface operating on radio frequencies with the wireless device within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the 3^{rd} Generation Partnership Project (3GPP), telecommunications suppliers propose and agree upon standards for third generation networks and further generations, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface. EPS is the Evolved 3GPP Packet Switched Domain. FIG. 1 is an overview of the EPC architecture. This architecture is defined in 3GPP TS 23.401 v.13.4.0 wherein a definition of a Packet Data Network Gateway (P-GW), a Serving Gateway (S-GW), a Policy and Charging Rules Function (PCRF), a Mobility Management Entity (MME) and a wireless or mobile device (UE) is found. The LTE radio access, E-UTRAN, comprises one or more eNBs. FIG. 2 shows the overall E-UTRAN architecture and is further defined in for example 3GPP TS 36.300 v.13.1.0. The E-UTRAN comprises eNBs, providing a user plane comprising the protocol layers Packet Data Convergence Protocol (PDCP)/Radio Link Control (RLC)/Medium Access Control (MAC)/Physical layer (PHY), and a control plane comprising Radio Resource Control (RRC) protocol in addition to the user plane protocols towards the wireless device. The radio network nodes are interconnected with each other by means of the X2 interface. The radio network nodes are also connected by means of the S1 interface to the EPC, more specifically to the MME by means of an S1-MME interface and to the S-GW by means of an S1-U interface.

Automatic Neighbor Relations (ANR) is a beneficial feature in LTE, whereby neighbor relations between cells and between radio network nodes are automatically discovered and inter-radio network node interfaces (X2) can be established (in the inter-radio network nodes neighbor case), so that the neighborship parameters can be configured. This is a very useful procedure that relieves the operator from manual configuration of neighbor lists.

The ANR feature includes that a radio network node requests a wireless device to not only measure on and read the Physical Cell ID (PCI) of nearby cells, but also read and report back parts of the system information. The measurement serves to determine that the detected cell is indeed a suitable neighbor and the other information enables the radio network node and the network to automatically establish the relationship and X2 interface between the involved radio network nodes, in the case where the discovered cell belongs to another radio network node. FIG. 3 illustrates principles of ANR in LTE. It is further described in chapter 22.3.3 in 3GPP TS 36.300 v.13.0.0. In action 1, the wireless device receives a Physical Cell ID (PCI) from a neighbor eNB. Action 2; the wireless device reports a measurement report to the serving eNB of the PCI. Action 3; the serving eNB schedules a measurement gap for retrieving further information. Action 4; the serving eNB requests further ANR info from the wireless device. Action 5; the wireless device reads in the measurement gap E-UTRAN Cell Global Identifier (ECGI); Public Land Mobile Network (PLMN) ID; Tracking Area Code (TAC); and e.g. Closed Subscriber Group (CSG) ID. Action 6; the wireless device reports ANR info to the serving eNB such as ECGI, PLMN ID, TAC, and/or CSG ID. Action 7; from the received ANR info the serving eNB may look up IP address of neighbour eNB. Action 8; the serving eNB and the neighbor eNB may then establish an X2 connection, if needed, and a neighbour relation.

A similar feature would be equally useful and beneficial in upcoming wireless communication networks such as the yet to be standardized 5G systems, where it will have to adhere to the general design principles of e.g. 5G, including the lean design principle, e.g. avoid always-on transmissions.

The lean design principle of e.g. 5G system, including avoidance of always-on transmissions poses a problem for automatic inter-RAN node relationship establishment in these systems. It means that solution in LTE is not optimal, since ANR in LTE relies on always-on signals like the PCI and the system information.

### SUMMARY

An object of embodiments herein is to provide a mechanism for improving performance of the wireless communication network in an efficient manner.

According to an aspect the object is achieved by a method performed by a first radio network node for enabling detection of one or more radio network nodes in a wireless communication network. The first radio network node triggers an initiation of a transmission of a signal of identification from the one or more radio network nodes. The first radio network node triggers the transmission by transmitting a request to a network node requesting activation of the transmission of the signal of identification from the one or more radio network nodes.

According to another aspect the object is achieved by a method performed by a network node for enabling detection of a second radio network node in a wireless communication network. The network node determines to activate a transmission of a signal of identification from one or more radio network nodes respectively. Furthermore, the network node selects a set of one or more radio network nodes, which set comprises the second radio network node. The network node initiates an activation of the transmission of the signal of identification from each radio network node of the selected set of one or more radio network nodes comprising the second network node.

According to yet another aspect the object is achieved by a method performed by a second radio network node for enabling detection of the second radio network node in a wireless communication network. The second radio network node receives a request from a network node, being a core network node or an operation and maintenance node, which request requests activation of a transmission of a signal of identification. The second radio network node further activates the transmission of the signal of identification.

According to still another aspect the object is achieved by a method performed by a wireless device for enabling detection of a second radio network node in a wireless communication network. The wireless device receives information from a first radio network node, which information comprises an identity of a signal of identification and/or timing information of the signal of identification and/or frequency information of the signal of identification. The wireless device then configures the wireless device, i.e. sets settings in itself, for listening for the signal of identification based on the received information for detecting the second radio network node.

According to yet still another aspect the object is achieved by providing a first radio network node for enabling detection of one or more radio network nodes in a wireless communication network. The first radio network node is configured to trigger an initiation of a transmission of a signal of identification from the one or more radio network nodes, by being configured to transmit a request to a network node requesting activation of the transmission of the signal of identification from the one or more radio network nodes.

According to a further aspect the object is achieved by providing a network node for enabling detection of a second radio network node in a wireless communication network. The network node is configured to determine to activate a transmission of a signal of identification from one or more radio network nodes respectively, and to select a set of one or more radio network nodes, which set comprises the second radio network node. The network node is further configured to initiate an activation of the transmission of the signal of identification from each radio network node of the selected set comprising the second network node.

According to another aspect the object is achieved by providing a second radio network node for enabling detection of the second radio network node in a wireless communication network. The second radio network node is configured to receive a request from a network node, being a core network node or an operation and maintenance node, which request requests activation of a transmission of a signal of identification. The second radio network node is further configured to activate the transmission of the signal of identification.

According to yet another aspect the object is achieved by providing a wireless device for enabling detection of a second radio network node in a wireless communication network. The wireless device is configured to receive information from a first radio network node, which information comprises an identity of a signal of identification and/or timing information of the signal of identification and/or frequency information of the signal of identification. The wireless device is further configured to configure the wireless device for listening for the signal of identification based on the received information for detecting the second radio network node.

It is furthermore provided herein a computer program comprising instructions, which, when executed on at least one processor, cause the at least one processor to carry out any of the methods above, as performed by the radio network nodes, the network node or the wireless device. It is additionally provided herein a computer-readable storage medium, having stored thereon a computer program comprising instructions which, when executed on at least one processor, cause the at least one processor to carry out the method according to any of the methods above, as performed by the radio network nodes, the network node or the wireless device.

By activating signals of identification only upon demand of the first radio network node or network node the signaling is provided only when needed and in an efficient manner leading to an improved performance of the wireless communication network.

### BRIEF DESCRIPTION OF THE DRAWINGS

Embodiments will now be described in more detail in relation to the enclosed drawings, in which:

FIG. 1 is a schematic overview depicting a wireless communication network according to prior art;

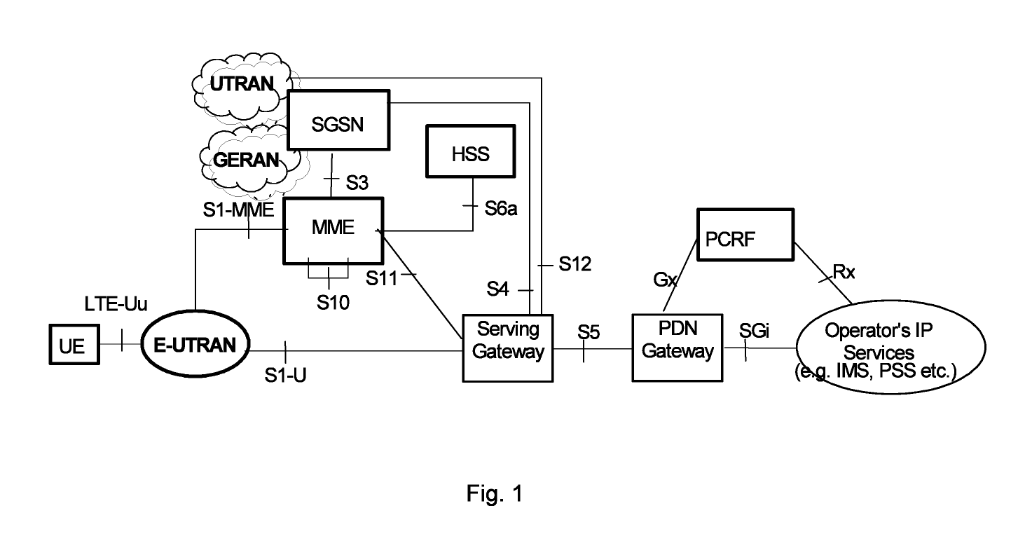

FIG. 2 is a schematic overview depicting a radio access network in connection with a core network;

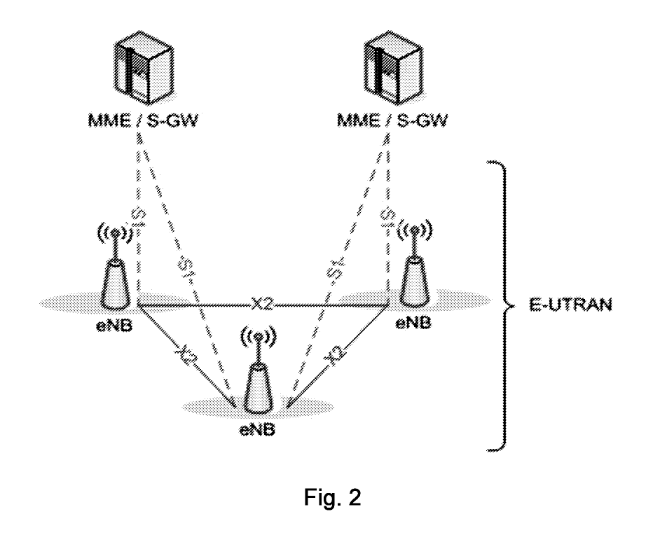

FIG. 3 is a schematic overview depicting an ANR process according to prior art;

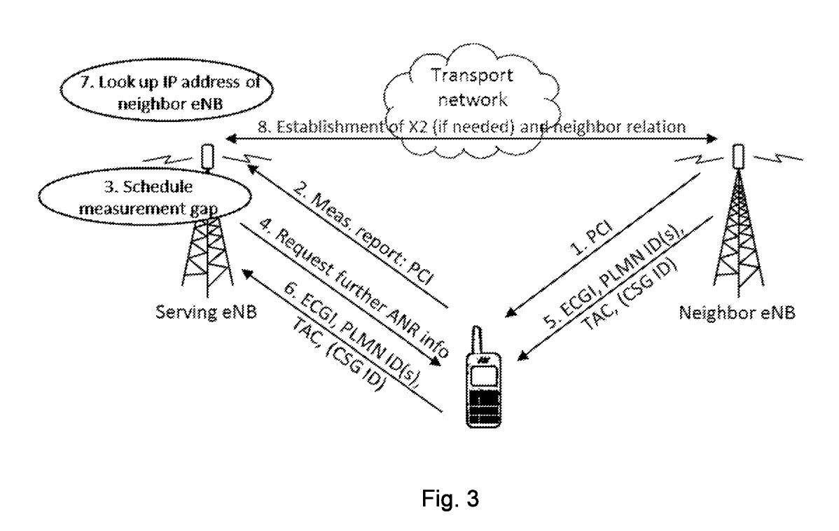

FIG. 4a is a schematic overview depicting a wireless communication network according to embodiments herein;

FIG. 4b is a schematic flowchart depicting a method performed by a first radio network node according to embodiments herein;

FIG. 4c is a schematic flowchart depicting a method performed by a network node according to embodiments herein;

FIG. 4d is a schematic flowchart depicting a method performed by a second radio network node according to embodiments herein;

FIG. 4e is a schematic flowchart depicting a method performed by a wireless device according to embodiments herein;

FIG. 5 is a combined flowchart and signalling scheme according to embodiments herein;

FIG. 6 is a combined flowchart and signalling scheme according to embodiments herein;

FIG. 7 is a combined flowchart and signalling scheme according to embodiments herein;

FIG. 8 is an overview depicting modes of a wireless device;

FIG. 9 is a block diagram depicting a first radio network node according to embodiments herein;

FIG. 10 is a block diagram depicting a network node according to embodiments herein;

FIG. 11 is a block diagram depicting a second radio network node according to embodiments herein; and

FIG. 12 is a block diagram depicting a wireless device according to embodiments herein.

### DETAILED DESCRIPTION

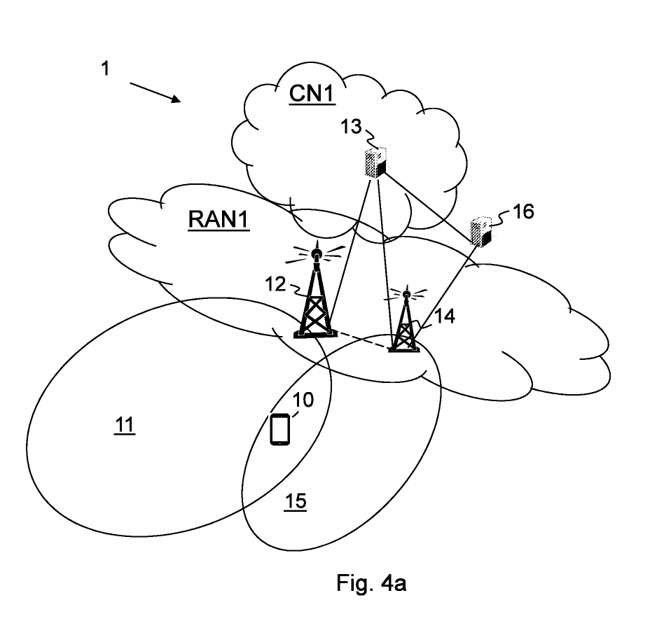

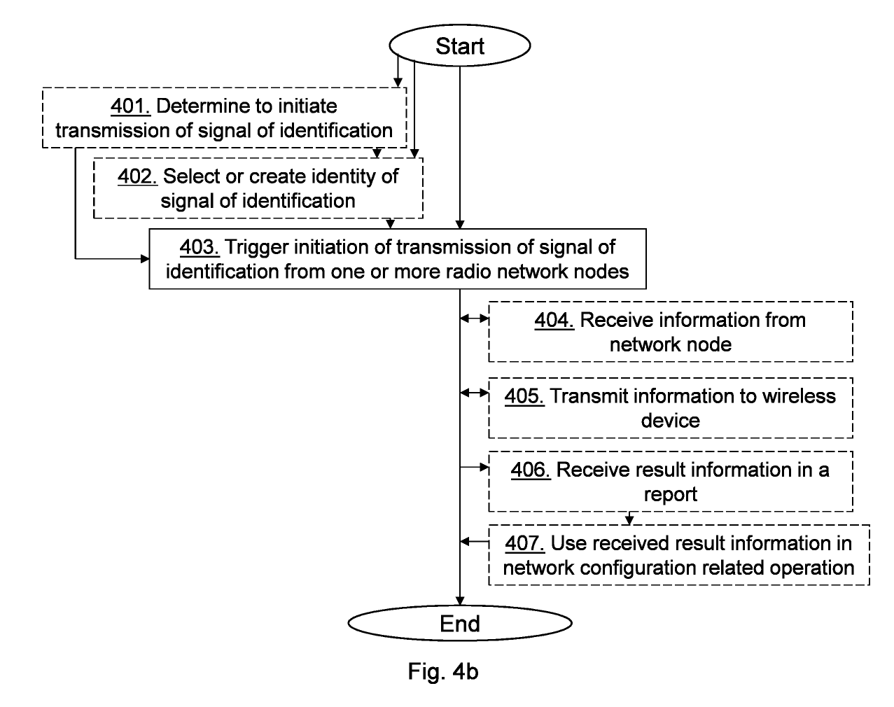

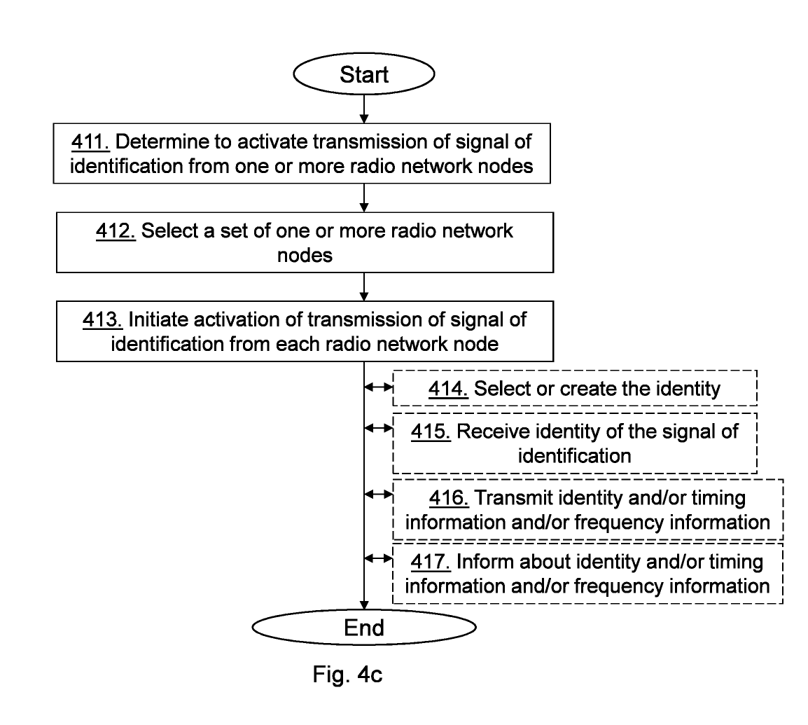

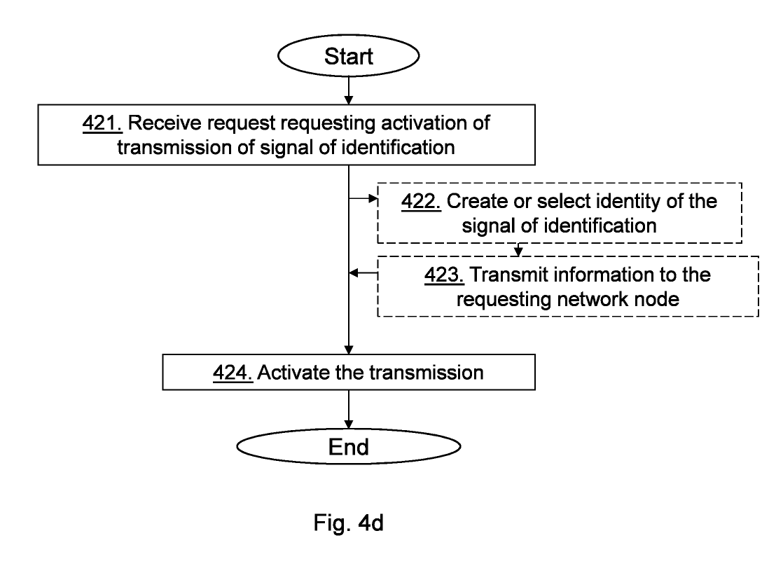

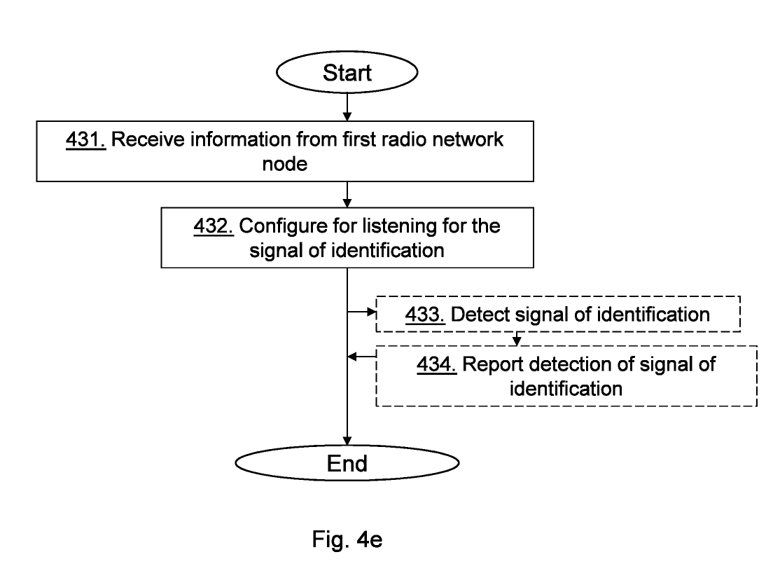

Embodiments herein relate to communication networks in general. FIG. 4a is a schematic overview depicting a wireless communication network 1. The wireless communication network 1 comprises one or more RANs e.g. a first RAN (RAN1), connected to one or more CNs, exemplified as a first CN (CN1). The wireless communication network 1 may use a number of different technologies, such as Wi-Fi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are applicable also in further development of the existing communication systems such as e.g. 3G and LTE.

In the wireless communication network 1, wireless devices e.g. a wireless device 10 such as a mobile station, a non-access point (non-AP) STA, a STA, a user equipment and/or a wireless terminal, are connected via the one or more RANs, to the CN. It should be understood by those skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or any device communicating within a cell or service area.

The wireless communication network 1 comprises a first radio network node 12 providing radio coverage over a geographical area, a first service area 11, of a first radio access technology (RAT), such as LTE, UMTS, Wi-Fi or similar. The first radio network node 12 may be a radio access network (RAN) node such as radio network controller, or an access point such as a wireless local area network (WLAN) access point or an Access Point Station (AP STA), an access controller, a base station, e.g. a radio base station such as a NodeB, an evolved Node B (eNB, eNodeB), a base transceiver station, Access Point Base Station, base station router, a transmission arrangement of a radio base station, a stand-alone access point or any other network unit capable of serving a wireless device within the service area served by the radio network node 12 depending e.g. on the first radio access technology and terminology used.

The wireless communication network 1 further comprises a core network node 13, e.g. an MME, of the CN1, for e.g. controlling the radio network nodes in the RAN1 or similarly.

Furthermore, the wireless communication network 1 comprises a second radio network node 14 providing radio coverage over a geographical area, a second cell or a second service area 15, of a second radio access technology (RAT), such as LTE, UMTS, Wi-Fi or similar. The second radio network node 14 has its own radio resource management (RRM) for the second service area 15. The second radio network node 14 may be a radio access network (RAN) node such as radio network controller or an access point such as a WLAN access point or an Access Point Station (AP STA), an access controller, a base station, e.g. a radio base station such as a NodeB, an evolved Node B (eNB, eNodeB), a base transceiver station, Access Point Base Station, base station router, a transmission arrangement of a radio base station, a stand-alone access point or any other network unit capable of serving a wireless device within the service area served by the second radio network node 14 depending e.g. on the second radio access technology and terminology used. The second radio network node 14 is comprised in the same or different RAN as the first radio network node 12 and the first and second RAT may be the same RAT or different RATs.

It should be noted that a service area may the denoted as ‘cell’, sector, beam, beam group or similar to define an area of radio coverage.

Furthermore, an operation and maintenance (O&M) system is comprised in the wireless communication network 1, comprising an O&M node 16 managing communication in the communication network 1. It should be noted that the O&M node 16 and the core network node 13 are commonly referred to as a network node.

As stated above there is a need for another type of solution than in LTE since ANR in LTE relies on always-on signals like the PCI and the system information.

In addition, there may be a need to avoid stable/static identifiers that can be associated with radio network nodes or locations to be transmitted over the air. The reason is to avoid that Over the Top (OTT) applications utilize such identifiers for location related services, and to some extent that it is desirable to reveal as little as possible of the network topology, e.g. in terms of node deployment.

Therefore, a new principle for e.g. automatic establishment of neighbor relations, in particular inter-RAN node neighbor relations, and other features related to detecting neighboring radio network nodes is herein provided, which addresses the above described problems. This is valid for Self Organizing Network (SON) features relying on radio network node or cell (or location-associated) identifiers, such as features where a wireless device collects information of visited radio network nodes/cells/locations/areas in idle, dormant and/or active mode and reports to the network on request. This may be used e.g. to estimate wireless device speed, to identify typical movement patterns, to optimize tracking areas and to generally aid in radio network planning.

Embodiments herein address the above described problems through a concept of on-demand activation of temporary transmissions of signals of identification, also referred to as identification signals. The signals of identification or ID signals, e.g. identity parameters or reference signal sequences, are dynamically generated and associations with radio network nodes or locations are created ad-hoc. The transmissions of signals of identification are activated in relevant radio network nodes or network nodes to support ANR or other SON features when these features are activated. In the case of ANR, relevant radio network nodes may comprise the radio network nodes that are reasonably likely to be neighbors of a triggering radio network node that wishes to discover neighboring radio network nodes. These relevant radio network nodes can be determined e.g. based on geographical proximity with the triggering radio access node. In the case of other SON features, the relevant radio network nodes may, depending on the nature of the SON feature, be radio access network nodes within a geographical area, which may be the entire network, in which data collection is desired. In most of the embodiments the core network node is the entity which is responsible for the overview of the area or radio network nodes that are involved in the execution of the feature and in which transmission of signals of identification should be activated. Embodiments herein solve the above described problems by using dynamically assigned signals of identification, which signals of identification are activated on a per need basis and dynamically associated with radio network nodes or locations. Hence, the lean, energy efficient design is achieved, OTT applications are prevented from utilizing the signals of identification for location related services, while the network features in need of identifiers of radio network nodes or identifiers associated with location, e.g. ANR and other SON features, can still be supported.

In some situations, e.g. the first radio network node 12 wants to identify and establish interfaces to suitable neighboring radio network nodes, which can be used for handover of wireless devices and various other features, such as Coordinated Multi Point (CoMP), Inter-Cell Interference Coordination (ICIC) and load balancing. Such situations may typically be when the first radio network node 12 has recently been deployed, when the first radio network node 12 has received an indication that the nearby environment has changed, e.g. an indication from the Operation and Maintenance (O&M) system that a new radio network node has been deployed in the vicinity of the first radio network node 12 or that the first radio network node 12 detects changes in the radio coverage possibilities in the first radio network node's service area. The first radio network node 12 may also initiate such operations periodically, e.g. as configured by the O&M system, in order to detect changes, such as newly deployed radio network nodes or changed transmission properties, e.g. due to changed antenna tilts or changed transmit power, of other radio network nodes in the vicinity of the first radio network node 12.

To initiate a search for nearby radio network nodes and/or establishment of inter-radio network node interfaces, a prerequisite is that there is one or more suitable wireless devices connected to the first radio network node 12, which wireless device can assist the first radio network node 12 in the operation, e.g. a wireless device close to the border of the first radio network node's service area. The first radio network node 12 would request such an assisting wireless device to search for signals of identification transmitted by other radio network nodes and report the result, possibly also including channel quality measurement results, to the first radio network node 12.

As mentioned above, embodiments herein are based on activation of signals of identification on a per need basis. Hence, to start the procedure these signals of identification have to be activated. Since the purpose of the procedure is to detect and e.g. establish interfaces and neighbor relations to radio network nodes in the vicinity of the first radio network node 12, the first radio network node 12 is naturally unaware of the existence of these possible other radio network nodes at this point in the procedure. The signal of identification may carry an identity (ID) of the second radio network node 14 or ID associated with the second radio network node such as cell ID being e.g. an explicit ID value, a reference signal e.g. consisting of a Zadoff-Chu sequence or similar. Thus, a sequence of signals may indicate identity associated with the second radio network node 14.

The method actions performed by the first radio network node 12 for enabling detection of one or more radio network nodes in the wireless communication network 1 according to some embodiments will now be described with reference to a flowchart depicted in FIG. 4b. The actions do not have to be taken in the order stated below, but may be taken in any suitable order. Actions performed in some embodiments are marked with dashed boxes. The detection of the one or more radio network nodes may be for the purpose of enabling a network configuration related operation.

Action 401. The first radio network node 12 may determine to initiate a transmission of the signal of identification.

Action 402. In some embodiments, the first radio network node 12 may select or create the identity of the signal of identification and/or timing information of the signal of identification and/or frequency information of the signal of identification.

Action 403. The first radio network node 12 triggers an initiation of a transmission of a signal of identification from the one or more radio network nodes by transmitting a request to a network node, such as the core network node 13 or the O&M node 16, requesting activation of the transmission of the signal of identification from the one or more radio network nodes. The request may comprise the identity of the signal of identification and/or the timing information of the signal of identification and/or the frequency information of the signal of identification. The first radio network node 12 may transmit the selected/created identity and/or the timing information and/or the frequency information in the request.

Action 404. Alternatively or additionally to the action 402, the first radio network node 12 may receive information from the network node, which information comprises the identity of the signal of identification and/or the timing information of the signal of identification and/or the frequency information of the signal of identification. It should be noted that the identity may be obtained from one source and the timing information of the signal of identification and/or the frequency information of the signal of identification may be obtained from same or different source. Hence, the first radio network node 12 may create or select the identity and receive the timing information from the core network node 13.

Action 405. The first radio network node 12 may transmit the information to the wireless device 10, which information comprises the identity of the signal of identification and/or the timing information of the signal of identification and/or the frequency information of the signal of identification.

Action 406. The first radio network node 12 may receive result information in a report from the wireless device 10, which result information is associated with the signal of identification from the one or more radio network nodes.

Action 407. The first radio network node 12 may then use the received result information in a network configuration related operation. The network configuration related operation may be a self-organizing network (SON) feature or a neighbour relationship operation e.g. ANR. Hence, the neighbour relationship operation may comprise establishing an interface and/or a connection to one or more of the one or more radio network nodes.

The method actions performed by the network node, exemplified herein as the core network node 13 or the O&M node 16, for enabling detection of one or more radio network nodes, e.g. the second radio network node 14, in the wireless communication network according to some embodiments will now be described with reference to a flowchart depicted in FIG. 4c. The actions do not have to be taken in the order stated below, but may be taken in any suitable order. Actions performed in some embodiments are marked with dashed boxes. Hence, embodiments herein may be for enabling a network configuration related operation in the wireless communication network 1.

Action 411. The network node determines to activate the transmission of the signal of identification from one or more radio network nodes respectively. For example, the network node may receive the request from the first radio network node 12 e.g. triggering the activation. The network node may receive a request from the operation and maintenance node 16. The received request may work as a trigger for the activation of the signal of identification.

Action 412. The network node selects a set of one or more radio network nodes, which set comprises the second radio network node 14. The set may thus comprise one or more radio network nodes.

Action 413. The network node initiates an activation of the transmission of the signal of identification from each radio network node of the selected set comprising the second network node 14. The network node may initiate the activation by transmitting a request to each one or more radio network nodes in the selected set, which request requests activation of the transmission of signal of identification.

Action 414. The network node may select or create the identity of the signal of identification and/or the timing information of the signal of identification and/or the frequency information of the signal of identification.

Action 415. The network node may receive, from the first radio network node 12 or another network node, the identity of the signal of identification and/or the timing information of the signal of identification and/or the frequency information of the signal of identification.

Action 416. The network node may then transmit the identity and/or the timing information and/or the frequency information to the respective one or more radio network nodes.

Action 417. The network node may inform the first radio network node 12 about the identity of the signal of identification and/or the timing information of the signal of identification and/or the frequency information of the signal of identification.

The method actions performed by the one or more radio network nodes in the set of one or more radio network nodes, exemplified herein as the second radio network node 14, for enabling detection of the second radio network node 14 in the wireless communication network according to some embodiments will now be described with reference to a flowchart depicted in FIG. 4d. The actions do not have to be taken in the order stated below, but may be taken in any suitable order. Actions performed in some embodiments are marked with dashed boxes. The embodiments herein may be for enabling detection of the second radio network node 14 for the purpose of enabling a network configuration related operation such as a SON feature or an ANR process.

Action 421. The second radio network node 14 receives the request from the network node, being the core network node 13 or the operation and maintenance node 16, which request requests activation of the transmission of the signal of identification. The request may comprise the identity of the signal of identification and/or the timing information of the signal of identification and/or the frequency information of the signal of identification for the transmission.

Action 422. The second radio network node 14 may select or create the identity of the signal of identification and/or the timing information of the signal of identification and/or the frequency information of the signal of identification.

Action 423. The second radio network node 14 may transmit a response to the requesting network node such as the network node, with the selected/created identity and/or the timing information and/or the frequency information of the signal of identification.

Action 424. The second radio network node 14 activates the transmission of the signal of identification. The transmission may e.g. comprise the selected/created identity. It may further comprise the timing information and/or the frequency information.

The method actions performed by the wireless device for enabling detection of the second radio network node 14 in the wireless communication network according to some embodiments will now be described with reference to a flowchart depicted in FIG. 4e. The actions do not have to be taken in the order stated below, but may be taken in any suitable order. Actions performed in some embodiments are marked with dashed boxes.

Action 431. The wireless device 10 receives information from the first radio network node 12, which information comprises the identity of the signal of identification and/or the timing information of the signal of identification and/or the frequency information of the signal of identification.

Action 432. The wireless device 10 configures the wireless device 10 for listening for the signal of identification based on the received information for detecting the second radio network node 14.

Action 433. The wireless device 10 may detect the signal of identification.

Action 434. The wireless device 10 may report to or via the first radio network node 12 detection of the signal of identification. The wireless device 10 may further report time information associated with the time of detection of the signal of identification, and/or report measurement information related to one or more measurements performed by the wireless device 10 on the detected signal of identification.

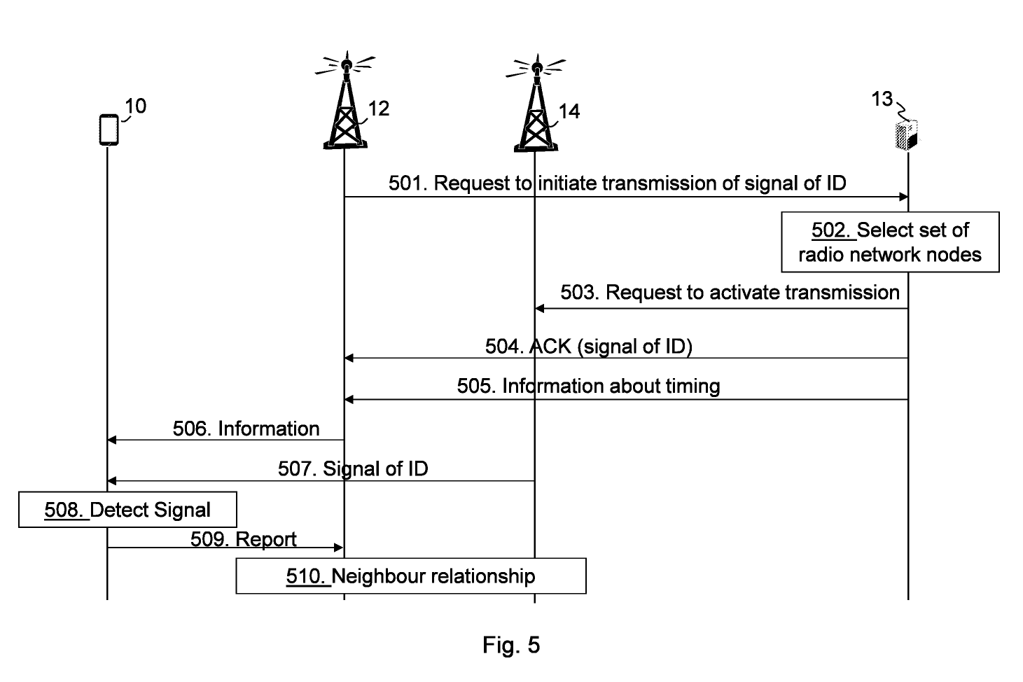

FIG. 5 is a combined flowchart and signaling scheme according to embodiments herein.

Action 501. The first radio network node 12 triggers the initiation of transmission of signal of identification by requesting the core network node 13 to initiate the transmission of signals of identification. E.g. the first radio network node 12 sends a request to e.g. an MME (or other core network node/entity) that the first radio network node 12 is connected to requesting to activate signals of identification to support detection of nearby radio network nodes. This may be performed when the first radio network node 12 has recently been deployed or upon a reception of an indication that the nearby environment has changed. This action corresponds to the action 403 in FIG. 4b.

Action 502. The core network node 13 in its turn selects a set of one or more radio network nodes to request initiation of transmission of signals of identification. To select such a suitable set of one or more radio network nodes the core network node 13 may use geographical information, e.g. site positions such as antenna site positions, or specifications of radio coverage areas, available for the radio network nodes connected to the core network node 13, e.g. the MME. This geographical information has preferably been provided to the core network node 13 from the radio network nodes when the radio network nodes were deployed, e.g. when an interface/connection between each radio network node and the core network node 13 was established. The core network node 13 may for instance use site location information from the requesting first radio network node 12 as an origin (center) of a geographical area such as a circle around the requesting first radio network node 12 and select all other radio network nodes located within that geographical area to be part of the set of one or more radio network nodes. The core network node 13 could also base the selection on information about the radio coverage areas of the respective radio network nodes and/or may also include transmit power information, e.g. received from each radio network node, e.g. when the interface between the radio network node and the core network node 13 was established, in the assessment of which radio network nodes that are suitable to include in the set of one or more radio network nodes. This action corresponds to the action 412 in FIG. 4c

Action 503. The core network node 13 requests the selected set of one or more radio network nodes, such as the second radio network node 14, to (temporarily) activate transmission of signals of identification, e.g. transmitting an activation request. This corresponds to action 413 in FIG. 4c. The core network node 13 may select, e.g. randomly generate, and provide the signals of identification for the second radio network node 14 to transmit. In this way the core network node 13 can ensure that the signals of identification are unique for each radio network node. Alternatively, each radio network node in the in the selected set of one or more radio network nodes, such as the second radio network node 14, can select, e.g. randomly generate, the signal(s) of identification itself and then inform the core network node 13 about the selected signal(s) of identification e.g. in a response to the activation request. Each radio network node may transmit one or more signal(s) of identification. For instance, if the second radio network node 14 supports only one cell, then one single signal would do, but if neighborships between sectors or beams need to be established, then the second radio network node 14 may support several sectors or beams that are regarded as potential neighbors, i.e. relevant in this ANR session, so that the second radio network node 14 may then transmit multiple different signals of identification. Uniqueness of each signal of identification may be ensured or improved by making the signal of identification long enough, i.e. providing a large number of possible signals of identification, so that a probability of a collision between any of the radio network nodes in the selected set of one or more radio network nodes is negligible. A hybrid of these methods is also conceivable, where the second radio network node 14 selects the signal(s) of identification for itself and then informs the core network node 13 of the signal and the core network node 13 then checks for and detects possible collisions or conflicts between signals of identification selected by different radio network nodes in the set of one or more radio network nodes. The core network node 13 may then request one or more of conflicting radio network nodes to select a new signal of identification to resolve the conflict.

Note that the 5G RAN may have a more distributed architecture than a traditional LTE RAN, e.g. with control and transmission responsibilities in separate entities e.g. a Cloud RAN comprising a RAN controller node and remote radio units (RRU) at distributed antenna sites, the RAN architecture may also consist of more entities, such as a Radio Controller Unit, a Baseband Unit, and a Packet Processing Unit. During detection of suitable radio network nodes and establishment of neighbor relations such as ANR and inter-RAN node interfaces, the first radio network node 12 initiating the procedure may be interested in both an indication of the entity associated with the transmissions, which will provide the signals of identification used in subsequent potential handovers, and an indication of the radio network node to which the inter-RAN node interface is to be established for communication such as handover control signaling or ICIC signaling, e.g. a controller node. In such a situation each entity associated with the transmission, e.g. each RRU, will transmit its own signal of identification and the signals of identification of all such entities belonging to the same controller node will also be associated with the controller node, e.g. a Radio Controller Unit or a Baseband Unit. For example, if a Baseband Unit (BBU) controls eight RRUs, then each RRU will be dynamically allocated a signal of identification of its own. This signal may be associated with this specific RRU, but it may also be associated with the BBU controlling the RRU. Similarly, if the RRU supports multiple beams to be part of an ANR session, then each beam will get a signal of its own. A signal will then be associated with a beam, but also with the BBU. In this case (i.e. the beam case) the signal may or may not also be associated with the RRU. A signal associated with a beam is, in practice, also automatically associated with the RRU too.

Action 504. When acknowledging the request from the requesting first radio network node 12, the core network node 13 informs the requesting first radio network node 12 of the signal of identification the involved second radio network node 14 will transmit. This corresponds to action 417 in FIG. 4c. This allows the requesting first radio network node 12 to inform the assisting wireless device 10 about the signal it should search for. Optionally, and preferably, the core network node 13 also informs the requesting first radio network node 12 of which radio network nodes, e.g. controller node, the different signals of identification belong to.

Action 505. The first radio network node 12 may receive timing information or information about timing from the core network node 13, which information is about a timing of the transmissions of the signals of identification, e.g. time windows or timeslots for each transmission and/or the time period/interval during which the transmissions of signals of identification will be active (and repeated). The timing information may also be complemented with frequency information, e.g. which frequency information may indicate range or which subcarriers that will be used for the transmission of each signal of identification. It is also possible that the first radio network node 12 only receives frequency information but no timing information. This also corresponds to the action 417 in FIG. 4c. The core network node 13 may have determined the information about the timing and or the frequency/frequencies of the transmission itself and requested the second radio network node 14 in the selected set of one or more radio network nodes to follow it, or received the from the second radio network node 14 in the selected set of one or more radio network nodes when the second radio network node 14 acknowledged the request to activate the transmission of signal(s) of identification, this acknowledgment is not shown in FIG. 5.

Action 506. The first radio network node 12 may pass/transmit information of one or more signals of identification and/or the timing information and/or frequency/frequencies information of the transmission on to the assisting wireless device 10 to aid the wireless device 10 in a detection (and possible measurement) process of the second radio network node 14. This corresponds to action 405 in FIG. 4a. When the activation request has been acknowledged by the core network node 13 in e.g. action 504/505, the initiating first radio network node 12, as described above, informs the assisting wireless device 10 of any facilitating information that the first radio network node 12 has, e.g. timing information, frequency information, identification signal information and/or repetition information. The initiating first radio network node 12 may also instruct the wireless device 10 to start a search/measurement procedure, immediately or at a certain point slightly ahead in time. The first radio network node 12 may create a so-called measurement gap for this purpose, during which any data transmission to the wireless device 10 is suspended, i.e. possible downlink data will be buffered in the first radio network node 12. The first radio network node 12 may optionally involve more than one assisting wireless device during a same transmission session/period of signals of identification in order to potentially detect more neighboring radio network nodes and utilize the transmissions of signals of identification more efficiently.

Action 507. The second radio network node 14 then transmits the signal of identification as requested. This corresponds to action 424 in FIG. 4d. The transmission of signal of identification may be activated for a time interval/period, a rather short period of time, which optionally may be specified by the first radio network node 12 in its request to the core network node 13 or preconfigured. During this time interval the transmission of signal of identification may be repeated multiple times. A signal of identification or identification signal may be a higher layer identifier, e.g. a radio network node or antenna site identifier, which could even be part of the system information, or it could be a reference signal, which may include a synchronization sequence, such as a reference signal containing a synchronization part and an identification part, or any other type of signal. The actual transmissions of the signals may be omnidirectional or beamformed. In the latter case the transmissions may be sequentially transmitted in different directions, e.g. a “beam sweep”, to cover the entire coverage area or a part of the coverage area where the assisting wireless device 10 is likely to be located. Such information of likely area or direction of the assisting wireless device 10 may optionally be provided by the core network node 13 in its request for activation of the transmission of signals of identification to the radio network nodes in the selected set. The core network node 13 may base this information on the geographical information that the core network node 13 has about the respective radio network nodes and the requesting first radio network node 12 may also include an estimation of the position of the assisting wireless device in the request to the core network node 13. Alternatively, the core network node 13 can inform the selected radio network nodes in the set of one or more radio network nodes about the geographical information of the requesting first radio network node 12 and let the selected radio network nodes determine or figure out themselves if and how to restrict the transmissions of signals of identification to a limited part of the coverage area. The requesting first radio network node 12 may assist this process further by providing the core network node 13 with an estimate of the location/position of the assisting wireless device 10.

Irrespective of the type of transmission, e.g. omnidirectional, beamformed, restricted to a coverage area part, the transmissions may be repeated multiple times to allow multiple opportunities for the wireless device 10 to receive the signal and also to collect more energy, to facilitate decoding, by receiving the same signal multiple times. In case of a beam sweep, the entire beam sweep may be repeated or each beam direction in the sweep may be repeated a number of times before a beam is transmitted in the next direction in the sweep. In some situations, the latter form of repetition, i.e. consecutive repetitions in the same beam direction, e.g. in consecutive timeslots, is preferable and may even be required, in conjunction with a beam sweep. This is when the assisting wireless device 10 relies on analog receive beamforming and can only try one reception direction at a time. Then the consecutive repetition of the signal of identification in the same beam direction allows the assisting wireless device 10 to try each of its reception beam directions, e.g. in a round robin fashion, for each set of repeated transmissions of signal of identification. As such repetitions may not always be useful, at least not equally beneficial, the repetition feature may be selectively used only when the assisting wireless device 10 have such limitations. The first radio network node 12 initiating the procedure may be aware of this property of the wireless device 10 from capability information received from the wireless device 10 and the first radio network node 12 may thus indicate, to the core network node 13, in the request to initiate the transmission of signals of identification, how many times each beam direction should be repeated, to match the number of reception beams the wireless device 10 will/has to try. Alternatively, the requesting first radio network node 12 may refrain from using wireless devices relying on analog receive beamforming as the assisting wireless devices, in order to make the neighbor identification procedure faster and more resource efficient.

Action 508. The wireless device 10 searches and detects zero or more signals of identification based on the received information from the first radio network node 12. This corresponds to action 433 in FIG. 4e.

Action 509. The wireless device 10 further reports the detected zero or more signals of identification, and preferably a reception quality indication such as received power, e.g. in the form of a Reference Signal Received Power (RSRP) value, or Signal to Noise Ratio (SNR) for each reported signal of identification. This corresponds to action 434 in FIG. 4e.

Action 510. The first radio network node 12 may use the signals of identification reported by the wireless device 10 to contact the radio network nodes associated with these reported signals of identification to establish neighbor relations and possible inter-radio network node interfaces/connections. This corresponds to action 407 in FIG. 4b. This possible inter-radio network node interface/connection may be established directly across the transport network or via, and assisted by, the core network. The first radio network node 12 may thus establish an X2 connection/s, S1 connection/s or a combination thereof or similar to the second radio network node 14 based on the signal of identification triggered by the first radio network node 12. If the core network node 13, when acknowledging the request for activation of transmission of signals of identification, did not inform the requesting first radio network node 12 about the mapping between each signal of identification and the associated radio network node, the part to be contacted for signaling and potential interface establishment in case of a distributed radio network node architecture, the first radio network node 12 has to contact the core network node 13 before neighbor relations and inter-radio network node interfaces/connections can be established. The first radio network node 12 may either ask the core network node 13 for the information about the radio network nodes associated with the detected signals of identification, so that the first radio network node 12 can contact these other radio network nodes, or ask the core network node 13 to mediate the contact between the radio network nodes, to enable establishment of neighbor relations and possible inter-radio network node interfaces/connections.

Furthermore, other SON features than establishment of neighbor relations, such as ANR, may rely on radio network node or cell identifiers or location-associated identifiers. This could for example be features where the wireless device 10 collects information of visited radio network nodes/cells/locations/areas in idle, dormant and/or active/connected mode and the wireless device 10 may report to the first radio network node 12 upon request. The reported information may be used e.g. to estimate speed of the wireless device 10, to identify typical movement patterns, to optimize tracking areas and to generally aid in radio network planning.

Such a feature may be activated in a certain area, e.g. a Tracking Area (TA)/Tracking RAN Area (TRA), a list of TAs/TRAs, a list of radio network nodes, a list of cells, selected types of radio network nodes, e.g. macro nodes, pico nodes, certain frequency band(s), nodes using (or not using) beamforming, a geographically specified area or the entire Public Land Mobile Network (PLMN). Irrespective of the size of the area or the number and/or involved radio network nodes, the feature relies on activation of transmission of signals of identification by the concerned second radio network node 14 on demand by the first radio network node 12 or the by another node, such as the core network node 13 or the O&M node 16.

Note that the flow chart does not necessarily show all messages/actions. For instance, there may be a message acknowledging message/action 503. Moreover, some messages/actions in the figure may be optional or may be combined. For instance, message/action 505 could be regarded as optional (i.e. present in some embodiments but absent in others) and when it is used, it is preferably, but not necessarily, combined with message/action 504 into a single message/action.

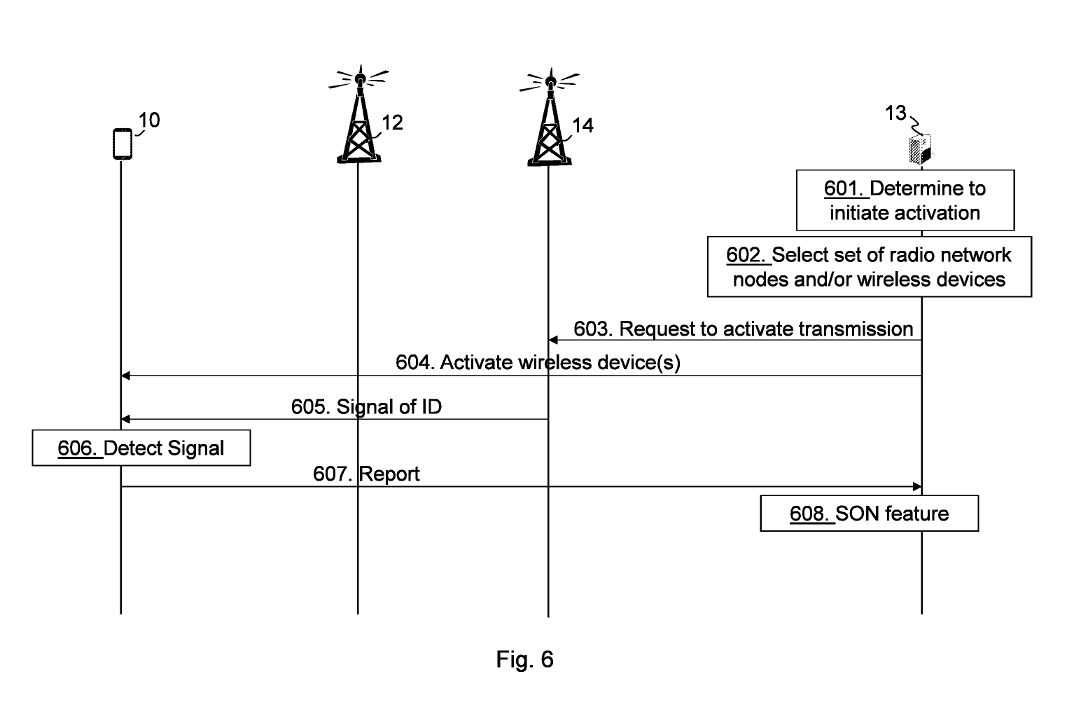

In one variant of the solution for support of other SON features than ANR the core network node 13 serves as the prime entity providing the overview of the concerned area and/or concerned radio network nodes and in another variant the O&M node 16 has this role. FIG. 6 shows a variant/embodiment where the core network node 13 has the responsibility for providing the overview of the area and/or radio network nodes that are concerned for a feature of SON in question.

Action 601. To activate the feature, the transmission of signals of identification has to be activated in the concerned second radio network node 12 and a certain set of wireless device(s) including e.g. the wireless device 10, have to be activated to start monitoring and recording signals of identification. The core network node 13 may act on its own initiative or upon request from the O&M node 16 or the first radio network node 12. Thus, the core network node 13 determines to initiate activation of transmissions of signal of identification. In any case the core network node 13 may request activation of the transmissions of the signal of identification in the second radio network node 14 in the same manner as described for the ANR feature above in FIG. 5. This corresponds to the action 411 in FIG. 4c.

Action 602. The core network node 13 selects a set of one or more radio network nodes being relevant for the feature. This corresponds to the action 412 in FIG. 4c. The core network node 13 may also select one or more of the wireless device(s) to activate in the set of wireless devices, e.g. based on subscription data or current location, e.g. TA/TRA, and trigger this activation, see action 604.

Action 603. The core network node 13 requests each radio network node out of the selected set of one or more radio network nodes, such as the second radio network node 14, to (temporarily) activate transmission of signals of identification, e.g. e.g. by transmitting an activation request. This corresponds to the action 413 in FIG. 4c.

Action 604. The core network node 13 may activate the one or more wireless device(s) including the wireless device 10 through Non Access Stratum (NAS) signaling or may request the first radio network node 12 to do it via RRC or MAC signalling, see action 431 in FIG. 4e. An alternative could be that the O&M node 16, or some entity responsible for some network measurement, tuning and/or optimization tasks, activates the selected wireless device(s) via SMS or Open Mobile Alliance Device Management (OMA DM).

Action 605. The second radio network node 14 then transmits the signal of identification as requested. This corresponds to the action 424 in FIG. 4d. If many radio network nodes across a large area are involved and are activated to transmit signals of identification, the signals may be geographically reused. The sequence of recorded signals and their associated timestamps reported from the wireless device 10 (from which a likely geographical trajectory can be deduced) will allow an analyzing entity, such as the core network node 13 or the O&M node 16, to determine which radio network node a wireless device 10 has received a reported signal from out of multiple radio network nodes that were transmitting the same signal. If the signals are periodically transmitted, e.g. with 10 ms interval, then the distinction of the reused signal may be facilitated by using different phases of the transmit period in different radio network nodes transmitting the same signal of identification, provided that the timestamp, which the wireless device 10 associates with a recorded timestamp, has fine enough granularity, e.g. less than half the smallest phase difference between the transmit periods of two radio network nodes transmitting the same signal of identification.

If a long period of active repeated signal of identification transmission is used for a certain feature, the signal of identification may be periodically changed to prevent temporary learning of signal to location associations, e.g. by an OTT app. The core network node 13 would control these periodical changes of signal of identification, e.g. based on instructions received from the O&M node 16, or the O&M node 16 could do it directly without assistance from the core network node 13. The core network node 13 or the O&M node 16 could send a new signal of identification to the second radio network node 14 whenever the previous one is to be replaced or the core network node 13 or the O&M node 16 may provide a batch of signals of identification to the second radio network node 14 together with instructions of when and how to switch between them. Such a batch may either be reused repetitively by the second radio network node 14 or be replaced by the core network node 13 or the O&M node 16 when it is finished. It is also possible to provide the second radio network node 14 with a batch of signals of identification which will last for the entire period during which signals of identification should be transmitted. The timestamps associated with recorded and reported signals of identification will allow an analyzing entity to match a reported received signal of identification with the radio network node that transmitted it.

Action 606. The wireless device 10 searches for and detects zero or more signals of identification based on the received information from the core network node 13 or the O&M node 16. This corresponds to the action 433 in FIG. 4e.

Action 607. The wireless device 10 further reports the detected zero or more signals of identification. This corresponds to the action 434 in FIG. 4e.The wireless device 10 may report its recorded data upon request, e.g. from the core network node 13 via NAS signalling, from the first radio network node 12 via RRC signalling, or from the O&M node 16 via OMA DM. The wireless device 10 may also be triggered to report its recorded data by an event. Such an event could be e.g. that a certain amount of data has been recorded or that the wireless device 10 has left the area in which the SON feature is activated or that a certain time has elapsed since the recording started. The latter could be that the wireless device 10 was configured to maintain the recording mechanism for a certain time, report the recorded data and then return to regular operation, i.e. operation without recording of signals of identification. The wireless device 10 could thus report to the first radio network node 12 or the core network node 13 or to the O&M node 16:
Via RRC (or MAC) signaling to the first radio network node 12 or any radio network node in the RAN or the particular first radio network node 12 in case of a very local SON function. The first radio network node 12 may forward the data to the core network node 13 or the O&M node 16 or some other entity. If forwarded to the core network node 13, the core network node 13 may further forward to the O&M node 16 or another entity.
To the core network node 13, e.g. using NAS signaling. The core network node 13 may forward the received data to O&M node 16 or another entity with the responsibility for some network measurement, tuning and/or optimization tasks.
To the O&M node 16 or another entity with the responsibility for some network measurement, tuning and/or optimization tasks. The means for reporting could be SMS, OMA DM, or some other protocol running on top of Transmission Control Protocol/Internet Protocol (TCP/IP), User Datagram Protocol (UDP)/IP, Stream Control Transmission Protocol (SCTP)/IP or plain IP.

If the recorded data is not reported directly to the O&M node 16, the entity of the first radio network node 12 that received the report may forward it to the O&M node 16, either unsolicited or on request. However, the recorded data may also be used to trigger actions in the wireless communication network, such as tuning antenna tilts or transmit power in the involved radio network nodes, e.g. the first radio network node 12 and/or the second radio network node 14, without involving the O&M node 16.

The reported data would typically consist of a list of received signal(s) of identification with associated timestamp(s), where the timestamp associated with the signal of identification indicates the time the wireless device 10 received and recorded the signal of identification. In addition, there may be associated samples of channel quality measurements or processed condensed representations thereof, such as average values, standard deviations, or percentiles.

Action 608. The core network node 13, the O&M node 16 or the first radio network node 12 (or any other involved radio network node) may then use the reported information e.g. to estimate speed of the wireless device 10, to identify typical movement patterns, to optimize tracking areas and to generally aid in radio network planning.

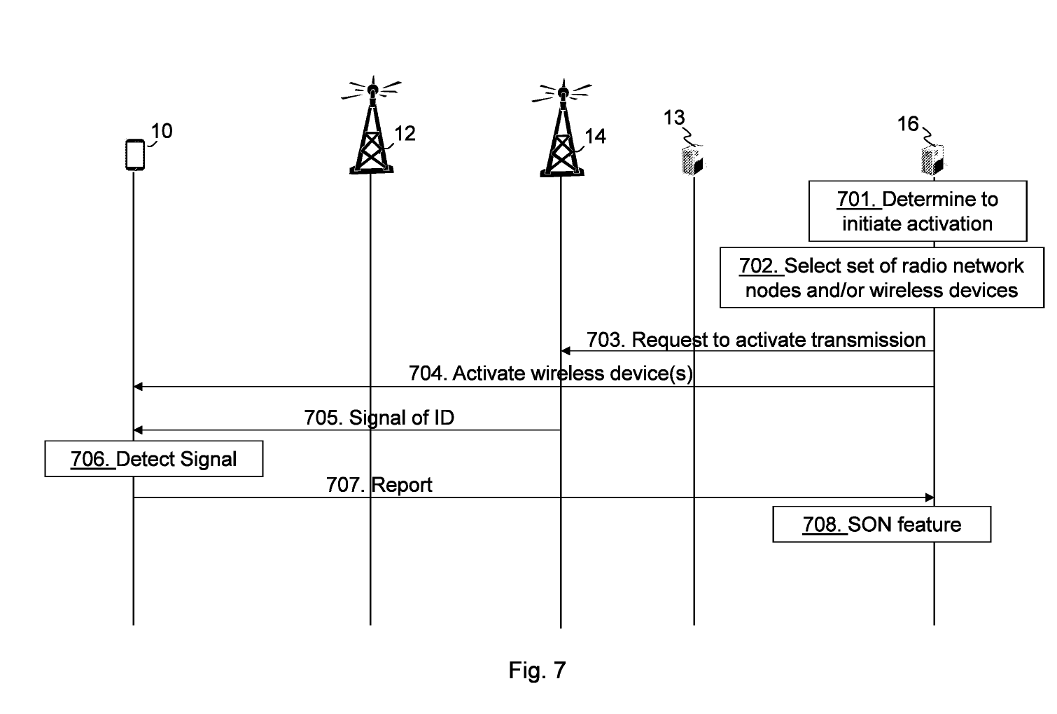

To provide a solution that avoids the above described problems in the background it is proposed to use signals of identification that are activated on a per need basis. This general concept can be applied both for automatic establishment of neighbor relations and for other SON features, but the details will differ. In both applications the core network node 13 has an important role as the entity that has the overview of the RAN through its connections to radio network nodes. However, in one embodiment for support of other SON features than ANR the O&M node 16 provides the overview of the area and the RAN nodes that are relevant for the concerned SON feature. This is shown in a combined flowchart and signaling scheme in FIG. 7. In this variant/embodiment the O&M node 16, or an entity responsible for some network measurement, tuning and/or optimization tasks or SON mechanisms in general, which—depending on definitions—may or may not be regarded as a part of the O&M node 16, has the prime responsibility for providing the overview of the area and/or radio network nodes that are concerned for the SON feature in question. The O&M node 16 takes in this illustrated embodiment the above described role of the core network node 13 in the initiation, preparation and activation of the signal of identification transmissions.

Action 701. The O&M node 16 determines to initiate activation of transmissions of signal of identification. This corresponds to the action 411 in FIG. 4c.

Action 702. Furthermore, the O&M node 16 selects the set of one or more radio network nodes, e.g. the second radio network node 14. This corresponds to the action 412 in FIG. 4c.

Action 703. The O&M node 16 then communicates directly with the selected set of radio network nodes to activate the transmission of respective signals of identification and optionally provides the signals of identification, and updates them when/if needed. This corresponds to the action 413 in FIG. 4c. If periodic replacement of signals of identification is used, as described above, this could be managed by the O&M node 16 too.

Action 704. The O&M node 16 may then further activate selected wireless devices, or all wireless devices in a relevant area, via SMS or OMA DM or to delegate to the first radio network node 12 or the core network node 13 to do that. When this activation is delegated to one or more radio network nodes such as the first radio network node 12, a further option is that the first radio network node 12 includes an indication of activation of the feature in the system information, i.e. an indication to wireless devices that are present in the coverage area of the first radio network node 12 that the wireless devices should initiate recording of the above described information, e.g. signals of identification, possibly associated timestamps and possibly associated measurement results.

Action 705. The second radio network node 14 then transmits the signal of identification as requested. This corresponds to the action 424 in FIG. 4d.

Action 706. The wireless device 10 detects and records detected data from the signal of identification. This corresponds to the action 433 in FIG. 4e.

Action 707. The wireless device 10 would typically report its recorded data to the entity that activated it, e.g. to the O&M node 16 using OMA DM or some other protocol running on top of TCP/IP, UDP/IP, SCTP/IP or plain IP, to the radio network node 12 using RRC or MAC or to the core network node 13 using NAS signaling. The reporting may be performed on request and then the report is sent in response to the request to the requesting entity. If the report is not sent directly to the O&M node 16, it may eventually end up there anyway through spontaneous, i.e. unsolicited, forwarding or through active retrieval, i.e. on request from the O&M node 16. This corresponds to the action 434 in FIG. 4e.

Action 708. The O&M node 16 may then use the reported information e.g. to estimate the speed of the wireless device 10, to identify typical movement patterns, to optimize tracking areas and to generally aid in radio network planning.

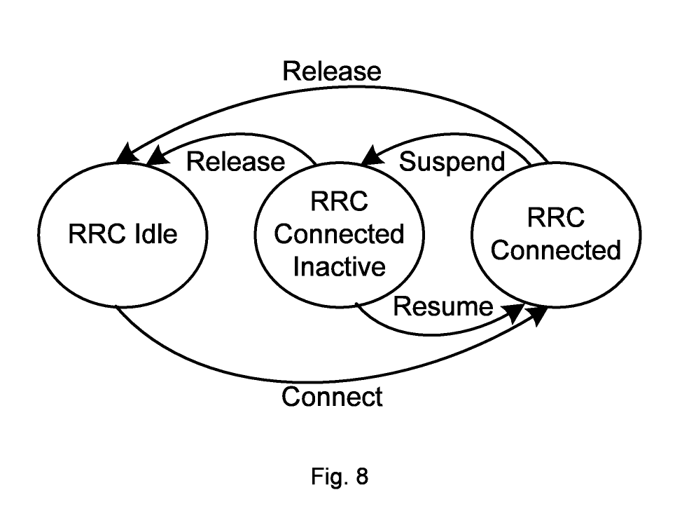

The wireless device 10 may be in one of the different RRC modes, e.g. Idle Mode, or Connected Mode. Within the Connected Mode, for e.g. 5G, the wireless device 10 may be in two different modes: Active, and Dormant, see in reference to FIG. 8. The Dormant mode is a hybrid mode/state between Connected Mode and Idle Mode, while the Active mode may be very similar to what RRC Connected Mode is in LTE.

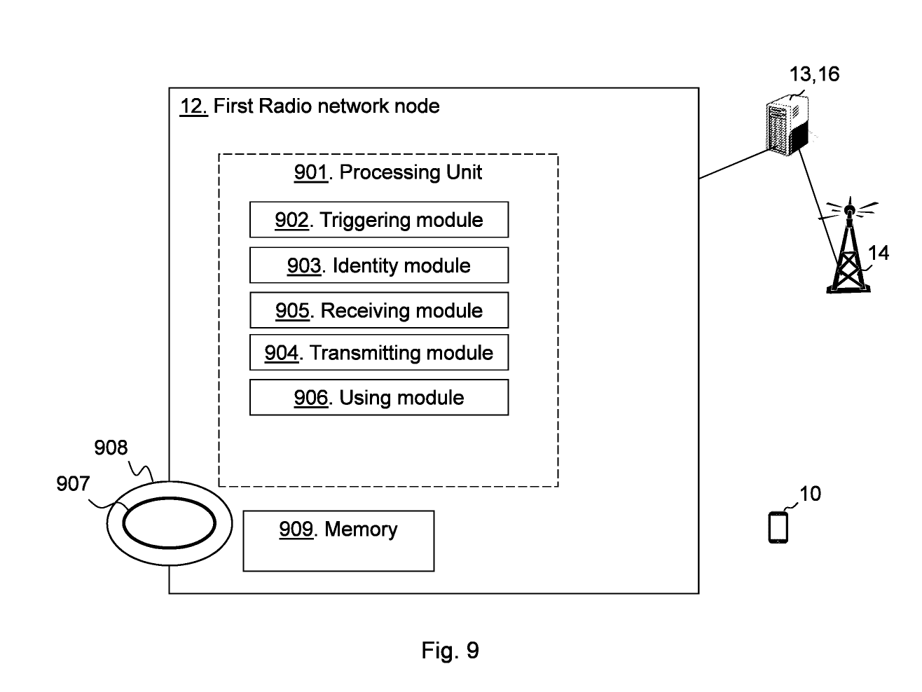

FIG. 9 is a block diagram depicting the first radio network node 12 for enabling detection of one or more radio network nodes in the wireless communication network 1. Some embodiments relate to for enabling detection of one or more radio network node for the purpose of enabling a network configuration related operation.

The first radio network node 12 comprises a processing unit 901, e.g. one or more processors, configured to perform the methods herein.

The first radio network node 12 may comprise a triggering module 902. The first radio network node 12, the processing unit 901, and/or the triggering module 902 may be configured to trigger the initiation of the transmission of the signal of identification from the one or more radio network nodes. The first radio network node 12, the processing unit 901, and/or the triggering module 902 may be configured to trigger the initiation by being configured to transmit the request to the network node, such as the core network node 13 or the O&M node 16, requesting activation of the transmission of the signal of identification from the one or more radio network nodes. The request may comprise the identity of the signal of identification and/or the timing information of the signal of identification and/or the frequency information of the signal of identification.

The radio network node may comprise an identity module 903. The first radio network node 12, the processing unit 901, and/or the identity module 903 may be configured to select or create the identity of the signal of identification and/or the timing information of the signal of identification and/or the frequency information of the signal of identification.

The radio network node may comprise a transmitting module 904. The first radio network node 12, the processing unit 901, and/or the transmitting module 904 may be configured to transmit the selected/created identity and/or the timing information and/or the frequency information in the request. The first radio network node 12, the processing unit 901, and/or the transmitting module 904 may be configured to transmit information to the wireless device, which information comprises the identity of the signal of identification and/or the timing information of the signal of identification and/or the frequency information of the signal of identification.

The radio network node may comprise a receiving module 905. The first radio network node 12, the processing unit 901, and/or the receiving module 905 may be configured to receive information from the network node, which information comprises the identity of the signal of identification and/or the timing information of the signal of identification and/or the frequency information of the signal of identification. The first radio network node 12, the processing unit 901, and/or the receiving module 905 may be configured to receive result information in the report from the wireless device 10, which result information is associated with the signal of identification from the one or more radio network nodes, e.g. cell ID or measurement of second cell 15 associated with the second radio network node 14.

The radio network node may comprise a using module 906. The first radio network node 12, the processing unit 901, and/or the using module 906 may be configured to use the received result information in the network configuration related operation. The network configuration related operation may be a self-organizing network feature or a neighbour relationship operation.

The methods according to the embodiments described herein for e.g. the first radio network node 12 are respectively implemented by means of e.g. a computer program 907 or a computer program product, comprising instructions, i.e., software code portions, which, when executed on at least one processor, cause the at least one processor to carry out the actions described herein, as performed by the first radio network node 12. The computer program 907 may be stored on a computer-readable storage medium 908, e.g. a disc or similar. The computer-readable storage medium 908, having stored thereon the computer program, may comprise the instructions which, when executed on at least one processor, cause the at least one processor to carry out the actions described herein, as performed by the first radio network node 12. In some embodiments, the computer-readable storage medium may be a non-transitory computer-readable storage medium.

The first radio network node further comprises a memory 909. The memory comprises one or more units to be used to store data on, such as thresholds, Cell IDs, measurements, identities of signals of identification, timing information, frequency information, applications to perform the methods disclosed herein when being executed, and similar.

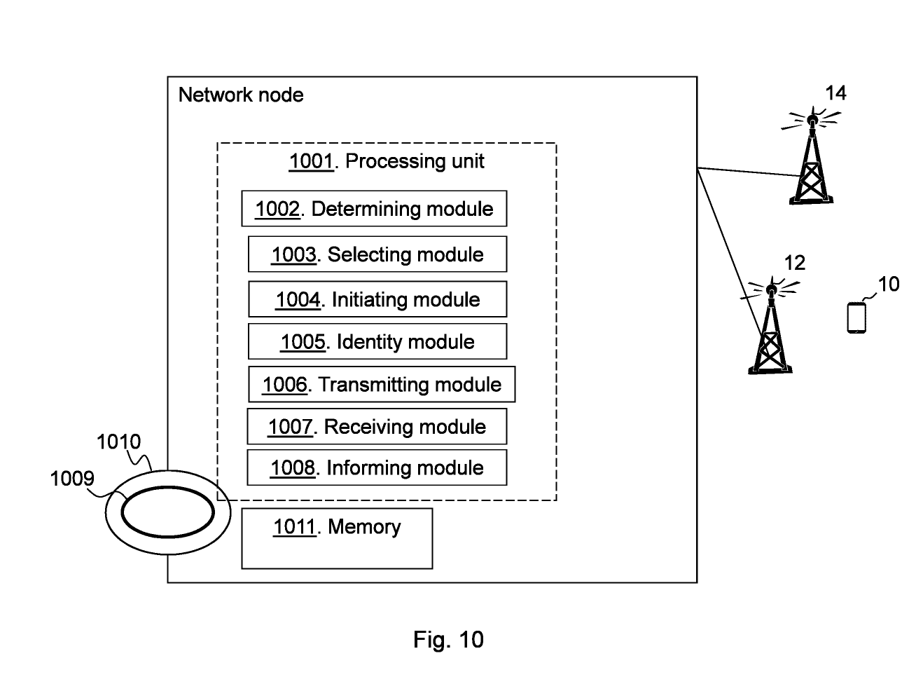

FIG. 10 is a block diagram depicting the network node, such as the core network node 13 or the O&M node 16 for enabling detection of the second radio network node 14 in the wireless communication network 1.

The network node comprises a processing unit 1001, e.g. one or more processors, configured to perform the methods herein.

The network node may comprise a determining module 1002. The network node, the processing unit 1001, and/or the determining module 1002 may be configured to determine to activate the transmission of the signal of identification from one or more radio network nodes respectively. The network node, the processing unit 1001, and/or the determining module 1002 may be configured to determine to activate the transmission by being configured to receive the request from the first radio network node 12. The network node, being the core network node 13, the processing unit 1001, and/or the determining module 1002 may be configured to determine to activate the transmission by being configured to receive the request from the operation and maintenance node 16.

The network node may comprise a selecting module 1003. The network node, the processing unit 1001, and/or the selecting module 1003 may be configured to select the set of one or more radio network nodes, which set comprises the second radio network node 14.

The network node may comprise an initiating module 1004. The network node, the processing unit 1001, and/or the initiating module 1004 may be configured to initiate the activation of the transmission of the signal of identification from each radio network node of the selected set comprising the second network node 14. The network node, the processing unit 1001, and/or the initiating module 1004 may be configured to initiate the activation by being configured to transmit the request to each one or more radio network nodes in the selected set, which request requests activation of the transmission of signal of identification.

The network node may comprise an identity module 1005. The network node, the processing unit 1001, and/or the identity module 1005 may be configured to select or create an identity of the signal of identification and/or the timing information of the signal of identification and/or the frequency information of the signal of identification.

The network node may comprise a transmitting module 1006. The network node, the processing unit 1001, and/or the transmitting module 1006 may be configured to transmit the identity and/or the timing information and/or the frequency information to the respective one or more radio network nodes.

The network node may comprise a receiving module 1007. The network node, the processing unit 1001, and/or the receiving module 1007 may be configured to receive from the first radio network node 12 or another network node, the identity of the signal of identification and/or the timing information of the signal of identification and/or the frequency information of the signal of identification. The network node, the processing unit 1001, and/or the transmitting module 1006 may be configured to transmit the identity and/or the timing information and/or the frequency information to the respective one or more radio network nodes.

The network node may comprise an informing module 1008. The network node, the processing unit 1001, and/or the informing module 1008 may be configured to inform the first radio network node 12 about the identity of the signal of identification and/or the timing information of the signal of identification and/or the frequency information of the signal of identification.

The methods according to the embodiments described herein for e.g. network node are respectively implemented by means of e.g. a computer program 1009 or a computer program product, comprising instructions, i.e., software code portions, which, when executed on at least one processor, cause the at least one processor to carry out the actions described herein, as performed by the network node. The computer program 1009 may be stored on a computer-readable storage medium 1010, e.g. a disc or similar. The computer-readable storage medium 1010, having stored thereon the computer program, may comprise the instructions which, when executed on at least one processor, cause the at least one processor to carry out the actions described herein, as performed by the network node. In some embodiments, the computer-readable storage medium may be a non-transitory computer-readable storage medium.

The network node further comprises a memory 1011. The memory comprises one or more units to be used to store data on, such as thresholds, Cell IDs, identities of signals of identification, timing information, frequency information, applications to perform the methods disclosed herein when being executed, and similar.

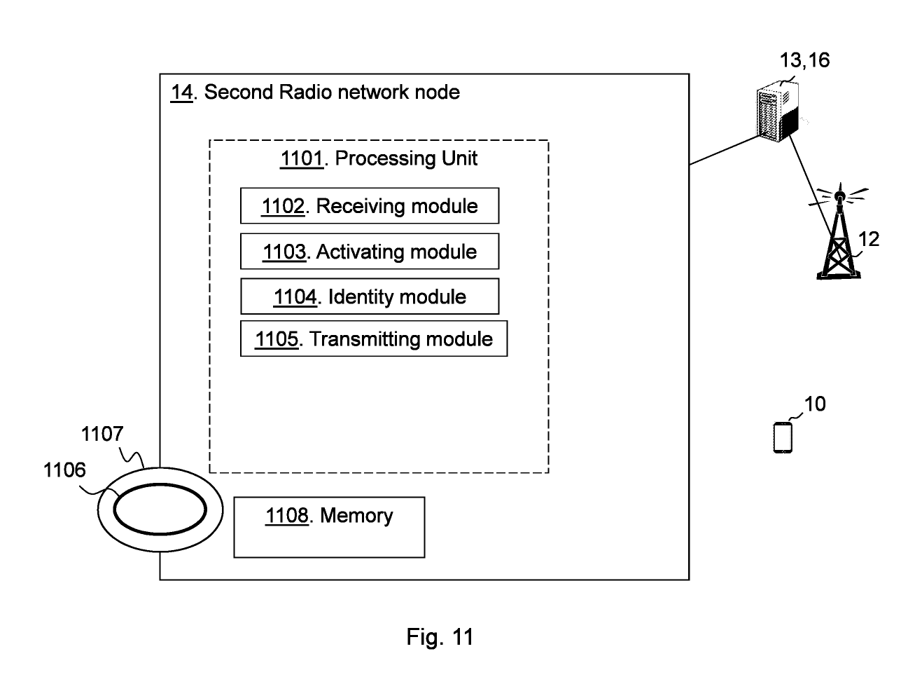

FIG. 11 is a block diagram depicting the second radio network node 14 for enabling detection of the second radio network node 14 in the wireless communication network. Some embodiments relate to for enabling detection of one or more radio network node for the purpose of enabling a network configuration related operation.

The second radio network node 14 comprises a processing unit 1101, e.g. one or more processors, configured to perform the methods herein.

The second radio network node 14 may comprise a receiving module 1102. The second radio network node 14, the processing unit 1101, and/or the receiving module 1102 may be configured to receive the request from the network node, being the core network node 13 or the operation and maintenance node 16. The request requests activation of the transmission of the signal of identification. The request may comprise the identity of the signal of identification and/or the timing information of the signal of identification and/or the frequency information of the signal of identification for the transmission.

The second radio network node 14 may comprise an activating module 1103. The second radio network node 14, the processing unit 1101, and/or the activating module 1103 may be configured to activate the transmission of the signal of identification.

The second radio network node 14 may comprise an identity module 1104. The second radio network node 14, the processing unit 1101, and/or the identity module 1104 may be configured to select or create an identity of the signal of identification and/or the timing information of the signal of identification and/or the frequency information of the signal of identification. The transmission may comprise the selected/created or the received identity.

The second radio network node 14 may comprise a transmitting module 1105. The second radio network node 14, the processing unit 1101, and/or the transmitting module 1105 may be configured to transmit the response with the selected/created identity and/or the timing information and/or the frequency information of the signal of identification to the requesting network node.

The methods according to the embodiments described herein for e.g. the second radio network node 14 are respectively implemented by means of e.g. a computer program 1106 or a computer program product, comprising instructions, i.e., software code portions, which, when executed on at least one processor, cause the at least one processor to carry out the actions described herein, as performed by the second radio network node 14. The computer program 1106 may be stored on a computer-readable storage medium 1107, e.g. a disc or similar. The computer-readable storage medium 1107, having stored thereon the computer program, may comprise the instructions which, when executed on at least one processor, cause the at least one processor to carry out the actions described herein, as performed by the second radio network node 14. In some embodiments, the computer-readable storage medium may be a non-transitory computer-readable storage medium.

The second radio network node 14 further comprises a memory 1108. The memory comprises one or more units to be used to store data on, such as thresholds, Cell IDs, identities of signals of identification, timing information, frequency information, applications to perform the methods disclosed herein when being executed, and similar.

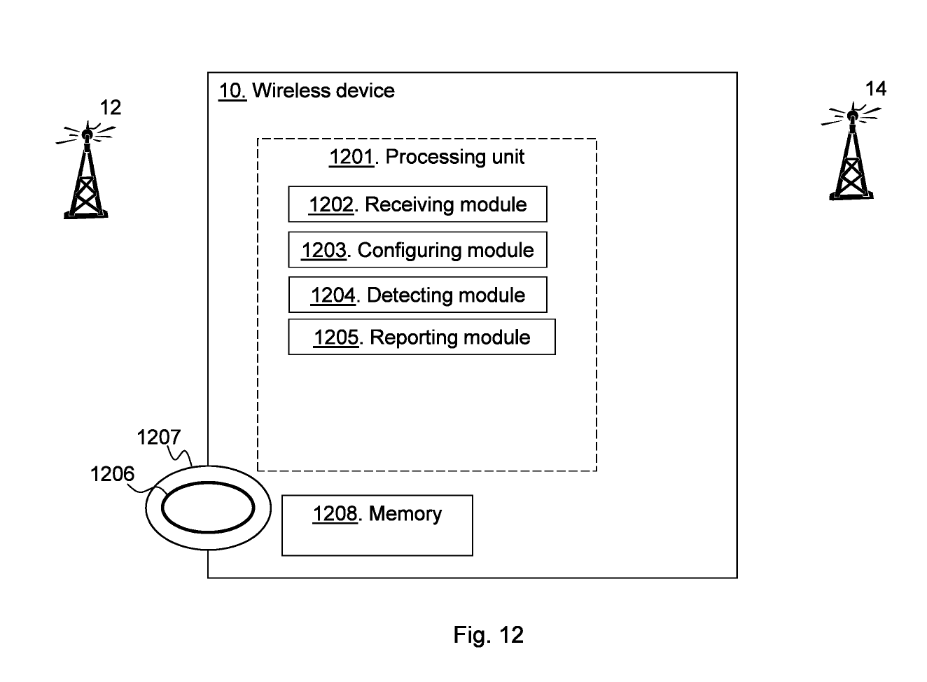

FIG. 12 is a block diagram depicting the wireless device 10 for enabling detection of the second radio network node 12 in the wireless communication network 1. Some embodiments relate to for enabling detection of one or more radio network node for the purpose of enabling a network configuration related operation.

The wireless device 10 comprises a processing unit 1201, e.g. one or more processors, configured to perform the methods herein.

The wireless device 10 may comprise a receiving module 1202. The wireless device 10, the processing unit 1201, and/or the receiving module 1202 may be configured to receive information from the first radio network node 12. The information comprises the identity of the signal of identification and/or the timing information of the signal of identification and/or the frequency information of the signal of identification.

The wireless device 10 may comprise a configuring module 1203. The wireless device 10, the processing unit 1201, and/or the configuring module 1203 may be adapted to configure the wireless device 10 for listening for the signal of identification based on the received information for detecting the second radio network node 14.

The wireless device 10 may comprise a detecting module 1204. The wireless device 10, the processing unit 1201, and/or the detecting module 1204 may be configured to detect the signal of identification.

The wireless device 10 may comprise a reporting module 1205. The wireless device 10, the processing unit 1201, and/or the reporting module 1205 may be configured to report to or via the first radio network node 12 detection of the signal of identification. The wireless device 10, the processing unit 1201, and/or the reporting module 1205 may be configured to report time information associated with the time of detection of the signal of identification. The wireless device 10, the processing unit 1201, and/or the reporting module 1205 may be configured to report measurement information related to one or more measurements performed by the wireless device 10 on the detected signal of identification.

The methods according to the embodiments described herein for e.g. the wireless device 10 are respectively implemented by means of e.g. a computer program 1206 or a computer program product, comprising instructions, i.e., software code portions, which, when executed on at least one processor, cause the at least one processor to carry out the actions described herein, as performed by the wireless device 10. The computer program 1206 may be stored on a computer-readable storage medium 1207, e.g. a disc or similar. The computer-readable storage medium 1207, having stored thereon the computer program, may comprise the instructions which, when executed on at least one processor, cause the at least one processor to carry out the actions described herein, as performed by the wireless device 10. In some embodiments, the computer-readable storage medium may be a non-transitory computer-readable storage medium.

The wireless device 10 further comprises a memory 1208. The memory comprises one or more units to be used to store data on, such as thresholds, Cell IDs, identities of signals of identification, timing information, measurements, frequency information, applications to perform the methods disclosed herein when being executed, and similar.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network nodes, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-44. (canceled)

45. A method performed by a first radio network node for enabling detection of one or more radio network nodes in a wireless communication network, the method comprising:
triggering an initiation of a transmission of a signal of identification from the one or more radio network nodes, wherein the triggering comprises transmitting a request to a network node requesting activation of the transmission of the signal of identification from the one or more radio network nodes.

46. The method according to claim 45, wherein the request comprises one or more of an identity of the signal of identification, timing information of the signal of identification, and frequency information of the signal of identification.

47. The method according to claim 46, further comprising:
selecting or creating one or more of the identity, the timing information, and the frequency information of the signal of identification; and
transmitting one or more of the identity, the timing information, and the frequency information in the request.

48. The method according to claim 45, further comprising:
receiving information from the network node, wherein the information from the network node comprises one or more of an identity of the signal of identification, timing information of the signal of identification, and frequency information of the signal of identification.

49. The method according to claim 45, further comprising:
transmitting information to a wireless device, wherein the information transmitted to the wireless device comprises one or more of an identity of the signal of identification, timing information of the signal of identification, and frequency information of the signal of identification.

50. The method according to claim 45, further comprising:
receiving result information in a report from a wireless device, wherein the result information is associated with the signal of identification from the one or more radio network nodes; and
using the received result information in a network configuration related operation.

51. The method according to claim 50, wherein the network configuration related operation is a self-organizing network feature or a neighbor relationship operation.

52. A method performed by a second radio network node for enabling detection of the second radio network node in a wireless communication network; the method comprising:
receiving a request from a network node, wherein the network node is a core network node or an operation and maintenance node, and wherein the request requests activation of a transmission of a signal of identification; and
activating the transmission of the signal of identification.

53. The method according to claim 52, wherein the request comprises one or more of an identity of the signal of identification, timing information of the signal of identification and frequency information of the signal of identification for the transmission.

54. The method according to claim 52, further comprising:
selecting or creating one or more of an identity of the signal of identification, timing information of the signal of identification and frequency information of the signal of identification, and wherein the transmission comprises the identity, and
wherein the method further comprises:
transmitting a response with one or more of the identity, the timing information and the frequency information to the requesting network node.

55. A method performed by a network node for enabling detection of a second radio network node in a wireless communication network, the method comprising:
determining to activate a transmission of a signal of identification from one or more radio network nodes, respectively;
selecting a set of radio network nodes from the one or more radio nodes, wherein the set comprises the second radio network node; and
initiating an activation of the transmission of the signal of identification from each radio network node of the set.

56. The method according to claim 55, wherein the determining comprises receiving a request from a first radio network node.

57. The method according to claim 55, wherein the determining comprises receiving a request from an operation and maintenance node.

58. The method according to claim 55, wherein the initiating comprises transmitting a request to each radio network node of the set, wherein the request requests activation of the transmission of the signal of identification.

59. The method according to claim 55, further comprising:
selecting or creating one or more of an identity of the signal of identification, timing information of the signal of identification and frequency information of the signal of identification; and
transmitting one or more of the identity, the timing information and the frequency information to the one or more radio network nodes.

60. The method according to claim 59, further comprising:
informing the first radio network node about one or more of the identity, the timing information and the frequency information.

61. The method according to claim 55, further comprising:
receiving, from a first radio network node or another network node, one or more of an identity of the signal of identification, timing information of the signal of identification and frequency information of the signal of identification; and
transmitting one or more of the identity, the timing information and the frequency information to the one or more radio network nodes.

62. A method performed by a wireless device for enabling detection of a second radio network node in a wireless communication network, the method comprising:
receiving information from a first radio network node, wherein the information comprises one or more of an identity of a signal of identification, timing information of the signal of identification and frequency information of the signal of identification; and
configuring the wireless device for listening for the signal of identification based on the received information, for detecting the second radio network node.

63. The method according to claim 62, further comprising:
detecting the signal of identification; and
reporting to or via the first radio network node the detection of the signal of identification.

64. The method according to claim 63, wherein the reporting further comprises reporting time information associated with the time of the detection of the signal of identification.

65. The method according to claim 63, wherein the reporting further comprises reporting measurement information related to one or more measurements performed by the wireless device on the detected signal of identification.

66. A first radio network node configured for enabling detection of one or more radio network nodes in a wireless communication network, the first radio network node comprising:
communication circuitry configured for communicating with a network node; and
processing circuitry operatively associated with the communication circuitry and configured to:
trigger an initiation of a transmission of a signal of identification from the one or more radio network nodes, by transmitting a request to the network node, requesting activation of the transmission of the signal of identification from the one or more radio network nodes.

67. The first radio network node according to claim 66, wherein the request comprises one or more of an identity of the signal of identification, timing information of the signal of identification and frequency information of the signal of identification.

68. The first radio network node according to claim 67, wherein the processing circuitry is configured to:
select or create one or more of the identity, the timing information and the frequency information of the signal of identification; and
transmit one or more of the identity, the timing information and the frequency information in the request.

69. The first radio network node according to claim 66, wherein the processing circuitry is configured to:
receive information from the network node, wherein the information comprises onr or more of an identity of the signal of identification, timing information of the signal of identification and frequency information of the signal of identification.

70. The first radio network node according to claim 66, wherein the processing circuitry is configured to:
transmit information to a wireless device, wherein the information comprises one or more of an identity of the signal of identification, timing information of the signal of identification and frequency information of the signal of identification.

71. The first radio network node according to claim 66, wherein the processing circuitry is configured to:
receive result information in a report from a wireless device, wherein the result information is associated with the signal of identification from the one or more radio network nodes; and
use the received result information in a network configuration related operation.

72. The first radio network node according to claim 71, wherein the network configuration related operation is a self-organizing network feature or a neighbor relationship operation.

73. A second radio network node configured for enabling detection of the second radio network node in a wireless communication network, the second radio network node comprising:
communication circuitry configured for communicating with a network node; and
processing circuitry operatively associated with the communication circuitry and configured to:
receive a request from the network node, wherein the network node is a core network node or an operation and maintenance node, and wherein the request requests activation of a transmission of a signal of identification; and
activate the transmission of the signal of identification.

74. The second radio network node according to claim 73, wherein the request comprises one or more of an identity of the signal of identification, timing information of the signal of identification and frequency information of the signal of identification for the transmission.

75. The second radio network node according to claim 73, wherein the processing circuitry is configured to:
select or create one or more of an identity of the signal of identification, timing information of the signal of identification and frequency information of the signal of identification, and wherein the transmission comprises the selected or created identity; and
transmit a response with one or more of the identity, the timing information and the frequency information to the requesting network node.

76. A network node configured for enabling detection of a second radio network node in a wireless communication network, the network node comprising:
communication circuitry configured for communicating with one or more radio network nodes, or for communicating with a node that is communicatively coupled to the one or more radio network nodes; and
processing circuitry operatively associated with the communication circuitry and configured to:
determine to activate a transmission of a signal of identification from the one or more radio network nodes, respectively;
select a set of radio network nodes from the one or more radio network nodes, wherein the set comprises the second radio network node; and
initiate an activation of the transmission of the signal of identification from each radio network node of the set.

77. The network node according to claim 76, wherein the processing circuitry is configured to determine to activate the transmission by receiving a request from a first radio network node.

78. The network node according to claim 76, wherein the processing circuitry is configured to determine to activate the transmission by receiving a request from an operation and maintenance node.

79. The network node according to claim 76, wherein the processing circuitry is configured to initiate the activation by transmitting a request to each radio network node of the set, and wherein the request requests activation of the transmission of the signal of identification.

80. The network node according to claim 76, wherein the processing circuitry is configured to:
select or create one or more of an identity of the signal of identification, timing information of the signal of identification and frequency information of the signal of identification; and
transmit one or more of the identity, the timing information and the frequency information to the one or more radio network nodes.

81. The network node according to claim 80, wherein the processing circuitry is configured to:
inform the first radio network node about one or more of the identity, the timing information and the frequency information.

82. The network node according to claim 76, wherein the processing circuitry is configured to:
receive from a first radio network node or another network node, one or more of an identity of the signal of identification, timing information of the signal of identification and frequency information of the signal of identification; and
transmit one or more of the identity, the timing information and the frequency information to the one or more radio network nodes.

83. A wireless device configured for enabling detection of a second radio network node in a wireless communication network, the wireless device comprising:
communication circuitry configured for communicating with a first radio network node; and
processing circuitry operatively associated with the communication circuitry and configured to:
receive information from the first radio network node, wherein the information comprises one or more of an identity of a signal of identification, timing information of the signal of identification and frequency information of the signal of identification; and
configure the wireless device for listening for the signal of identification based on the received information, for detecting the second radio network node.

84. The wireless device according to claim 83, wherein the processing circuitry is configured to:
detect the signal of identification; and
report to or via the first radio network node detection of the signal of identification.

85. The wireless device according to claim 84, wherein the processing circuitry is configured to report time information associated with the time of the detection of the signal of identification.

86. The wireless device according to claim 84, wherein the processing circuitry is configured to report measurement information related to one or more measurements performed by the wireless device on the detected signal of identification.

87. A non-transitory computer-readable storage medium, having stored thereon a computer program comprising instructions that, when executed on at least one processor of a first radio network node configured for enabling detection of one or more radio network nodes in a wireless communication network, cause the first radio network node to:
trigger an initiation of a transmission of a signal of identification from the one or more radio network nodes, by transmitting a request to a network node, requesting activation of the transmission of the signal of identification from the one or more radio network nodes.

88. A non-transitory computer-readable storage medium, having stored thereon a computer program comprising instructions that, when executed on at least one processor of a second radio network node configured for enabling detection of the second radio network node in a wireless communication network, cause the second radio network node to:
receive a request from a network node, wherein the network node is a core network node or an operation and maintenance node, and wherein the request requests activation of a transmission of a signal of identification; and
activate the transmission of the signal of identification.

89. A non-transitory computer-readable storage medium, having stored thereon a computer program comprising instructions that, when executed on at least one processor of a network node configured for enabling detection of a second radio network node in a wireless communication network, cause the network node to:
determine to activate a transmission of a signal of identification from the one or more radio network nodes, respectively;
select a set of one or more radio network nodes, wherein the set comprises the second radio network node; and
initiate an activation of the transmission of the signal of identification from each radio network node of the selected set comprising the second network node.

90. A non-transitory computer-readable storage medium, having stored thereon a computer program comprising instructions that, when executed on at least one processor of a network node configured for enabling detection of a second radio network node in a wireless communication network, cause the wireless device to:
receive information from the first radio network node, wherein the information comprises one or more of an identity of a signal of identification, timing information of the signal of identification and frequency information of the signal of identification; and
configure the wireless device for listening for the signal of identification based on the received information, for detecting the second radio network node.
